(19) United States
(12) Patent Application Publication
(10) Pub. No.: US 2018/0189092 A1
(43) Pub. Date: Jul. 5, 2018

(54) METHOD AND SYSTEM FOR SECURE EXECUTION OF VIRTUAL MACHINES BY A SET OF INTERCONNECTED PROGRAMMABLE DEVICES

(71) Applicant: Viaccess, Paris (FR)

(72) Inventor: Vicente Sanchez Leighton, Rennes (FR)

(21) Appl. No.: 15/741,220

(22) PCT Filed: Jun. 30, 2016
(86) PCT No.: PCT/EP2016/065342

§ 371 Date: Dec. 29, 2017

(30) Foreign Application Priority Data
Jul. 2, 2015 (FR) 15 56258

(51) Int. Cl. G06F 9/455; G06F 21/53; G06F 21/74

(52) U.S. Cl. CPC G06F 9/45558; G06F 21/53; G06F 21/74; G06F 2221/034; G06F 2009/45587; G06F 2009/45591; G06F 2009/4557

(57) ABSTRACT

The invention relates to a method and a system for secure execution of virtual machines by a set of interconnected programmable devices, each including at least one processor, each programmable device being able to execute applications of a plurality of virtual machines and including a hardware portion for standard security level execution and a secure hardware portion for a security level higher than the standard security level.

The method includes storing at least one secure execution environment (TEEi) associated with each virtual machine. Following a request for secure execution of a series of instructions of an application by a requesting virtual machine, it comprises allocating said secure execution at least one available secure hardware portion belonging to one of the interconnected processors, loading the secure execution environment (TEE1) associated with the requesting virtual machine (VM1) in the allocated secure hardware portion(s). The allocated secure hardware portion is used for the secure execution of the sequence of instructions.

The present invention relates to a method for the secure execution of virtual machines by a set of interconnected programmable devices, each programmable device including at least one computing processor, and an associated system for secure execution of virtual machines.

The invention falls within the field of the secure execution of virtual machines, and is particularly applicable to the execution of virtual machines in a centralized data processing system.

The secure execution of certain computer applications, said to be critical, is a major issue in many industrial and commercial settings.

The secure execution of a computer application, ensuring a certain level of security and robustness with respect to various pirate attacks, by a set of hardware resources, involves hardware or software partitioning of the hardware resources to produce a separation between an execution environment with a normal or standard security level and a secure execution environment.

The software separation is done, in a known manner, by a hypervisor mechanism or VMM (Virtual Machine Monitor). Owing to such a mechanism, different applications can be executed in memory environments isolated from one another of the standard security level hardware portion of a processor.

Hardware partitioning architectures are also known, for example the TrustZone® architecture by the company ARM®, which provides a processor provided with a secure hardware portion or area, partitioned relative to a hardware portion with a standard security level, lower than the so-called secure level. This partitioning is reflected by the ability of the processor to switch from a normal mode to a secure mode for which the hardware resources are physically isolated from the normal mode. These isolated hardware resources are for example memory, network resources, cryptographic accelerators. Likewise, the privilege level and the instructions authorized for execution by the processor are separate depending on the normal mode or the secure mode.

In the rest of the description, we will respectively refer to a hardware portion with standard security level and a secure hardware portion, to refer to the set of hardware resources implemented in the normal mode and in the secure mode of said processor. The switching from the normal mode to the secure mode is done on request from the normal mode using a specific instruction or during a hardware interruption from one of the hardware resources attached to the secure mode.

The handling of the request at the end of the switching from the normal mode to the secure mode is done by firmware of the processor. This firmware must be distinguished from the microcode of the processor, which is not accessible and which also defines the set of instructions of the processor.

This firmware is also executed during booting of the processor, which is done in secure mode such that a trust chain is established from the beginning. At the end of the boot sequence, the firmware initiates booting in the normal mode. The firmware is made up of a sequence of instructions of the processor having one of the highest privilege levels.

For example, in the case of processors with the ARM v8® architecture, the firmware of the processor makes it possible to use a given instruction, called SMC (Secure Monitor Call), which allows an application executed in the standard security level portion of the processor to go from execution parameters to request the execution of at least one instruction, said to be critical, of this application through the secure hardware portion of the processor.

Other architectures also exist providing similar functionalities, such as SGX® by Intel®, in the context of which the privilege levels are called CPU privilege rings.

Such an architecture ensures the execution, thus said to be secure, of at least one critical instruction of an application, in an isolated execution environment in the secure portion of the processor, called Trusted Execution Environment (TEE).

The application executed within the TEE (sometimes called “trustlet”) is made up of several sequences of instructions, which, depending on the design of the code (division into several threads), are optionally executed on several processor cores in parallel within a same TEE.

When several virtual machines, each including an operating system (OS), execute one or several applications on a same processor, a problem arises of sharing the secure hardware portion of the processor allowing isolated executions of the applications of each of the virtual machines. In this case, indeed, the separation provided by the hypervisor in the standard security portion of the processor is not ensured within the secure portion.

Furthermore, the use of sets of remote storage and computing servers by many virtual client machines, called “cloud computing”, is increasingly common. In such a context, many virtual machines seek to access the provided hardware resources. In general, these virtual machines belong to various owners. The problem of a possibility of secure execution, and in particular the problem mentioned above, is crucial in such a setting.

To resolve the latter problem, patent application US 2009/0204964 A1 proposes a distributed secure virtual platform, implementing a secure hypervisor architecture. The architecture proposes a software virtualization of TPM modules, which are encryption hardware components. The solutions based on these components are vulnerable to certain types of attacks. They in fact make it possible to verify the integrity of the loaded applications to be executed, but do not ensure hardware isolation of their executions. Alternatively, the hardware security modules (HSM) require dedicated processing units. Additionally, these modules are expensive.

The invention aims to resolve these drawbacks of the known solutions, by proposing a safer and less expensive solution for the secure execution of applications from multiple virtual machines implemented by a plurality of interconnected programmable devices.

To that end, the invention proposes a method for secure execution of virtual machines by a set of interconnected programmable devices, each programmable device including at least one computing processor having one or several cores, each programmable device being able to execute, simultaneously and/or successively, applications of a plurality of virtual machines, each processor including a hardware portion for standard security level execution and a secure hardware portion for a security level higher than the standard security level, said hardware portions being partitioned.

This method includes the following steps:
storing at least one secure execution environment associated with each virtual machine, each secure execution environment including at least one instruction of an associated application,
following a request for secure execution of at least one series of instructions of an application by a requesting virtual machine,
   allocating said secure execution at least one available secure hardware portion belonging to one of the processors of the set of interconnected programmable devices,
   loading the secure execution environment associated with said requesting virtual machine in said at least one allocated secure hardware portion,
   using the allocated secure hardware portion for the secure execution of said sequence of instructions of the application of the requesting virtual machine.

Advantageously, the invention makes it possible to successively use secure hardware portions of the processors of interconnected programmable devices, by various virtual machines, in a distributed manner, while ensuring the hardware partitioning of the executions. Additionally, the invention allows the exploitation of secure portions that are not used by the applications located in the respective standard security level hardware portions within a same processor.

The secure execution method for virtual machines according to the invention may have one or more of the features below, considered independently or according to all technically acceptable combinations:

The secure hardware portion comprises memory resources and the method includes, before loading the secure execution environment, a step for cleaning said memory resources.

The secure hardware portion comprises at least one peripheral, and the method includes, before loading the secure execution environment, a step for cleaning each peripheral.

The method further comprises an encryption of the secure execution environment after the secure execution of said sequence of instructions of the application of the requesting virtual machine, and storing of the encrypted secure execution environment.

After the secure execution request for at least one sequence of instructions of an application, the method comprises at least one step for evaluating necessary hardware resources for the secure execution environment associated with said requesting virtual machine, and computing a number of secure hardware portions to be allocated for the execution of the secure application in the associated secure execution environment.

Following a request for secure execution of at least one sequence of instructions of an application, the method comprises a step for computing a secure execution sequencing priority of the execution requests.

The evaluation of hardware resources comprises an evaluation of computing complexity and/or quantity of memory and/or number of execution cores.

The method comprises, for a plurality of execution requests from a plurality of requesting virtual machines, a distributed implementation of a sequencing algorithm for the use of groups of secure hardware portions by the secure execution environments associated with the requesting virtual machines.

The use of a secure hardware portion allocated for the secure execution of at least one instruction of the application of a first requesting virtual machine is exclusive, at a given moment, of any use of said secure hardware portion for the secure execution of at least one instruction of the application of a second requesting virtual machine.

According to another aspect, the invention proposes a system for secure execution of virtual machines by a set of interconnected programmable devices, each programmable device including at least one computing processor having one or several cores, each programmable device being able to execute, simultaneously and/or successively, applications of a plurality of virtual machines, each processor including a hardware portion for standard security level execution and a secure hardware portion for a security level higher than the standard security level, said hardware portions being partitioned.

Each processor includes firmware modules of said processor suitable for:
storing a secure execution environment associated with each virtual machine, each secure execution environment including at least one instruction of an associated application,
following a request for secure execution of at least one series of instructions of an application by a requesting virtual machine,
   allocating said secure execution at least one available secure hardware portion belonging to one of the processors of the set of interconnected programmable devices,
   loading the secure execution environment associated with said requesting virtual machine in said at least one allocated secure hardware portion,
   using the allocated secure hardware portion for the secure execution of said sequence of instructions of the application of the requesting virtual machine.

According to one embodiment, the system for secure execution of virtual machines includes shared memory resources, and an encryption module able to encrypt the secure execution environment after the secure execution of said at least one instruction of the application of the requesting virtual machine, and to save the encrypted secure execution environment in the shared memory resources.

According to another aspect, the invention relates to a computer program product including firmware instructions which, when implemented by one or several computing processors of programmable devices, each computing processor having one or several cores, each programmable device being able to execute, simultaneously and/or successively, applications of a plurality of virtual machines, each processor including a hardware portion for standard security level execution and a secure hardware portion for a security level higher than the standard security level, said hardware portions being partitioned, carry out a method as briefly described above.

Other features and advantages of the invention will emerge from the description thereof provided below, for information and non-limitingly, in reference to the appended figures, in which:

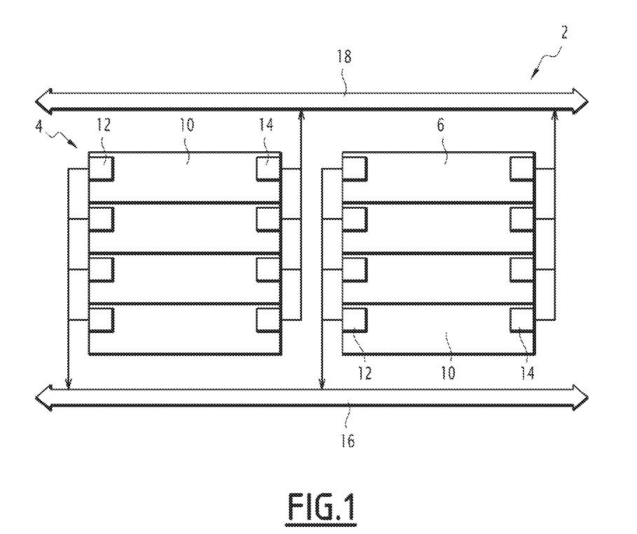

FIG. 1 schematically shows a centralized data processing system;

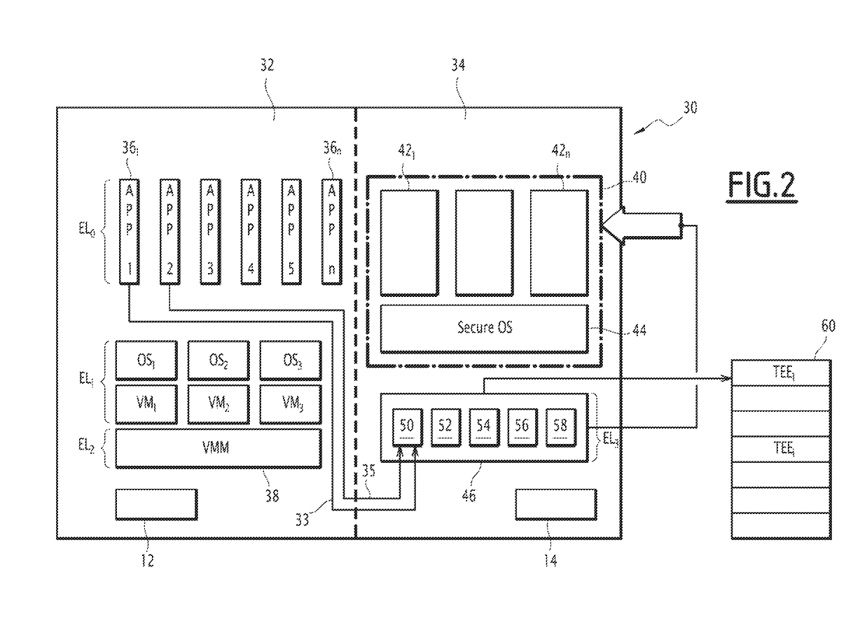

FIG. 2 schematically illustrates one embodiment of a processor of a programmable device in one embodiment of the invention;

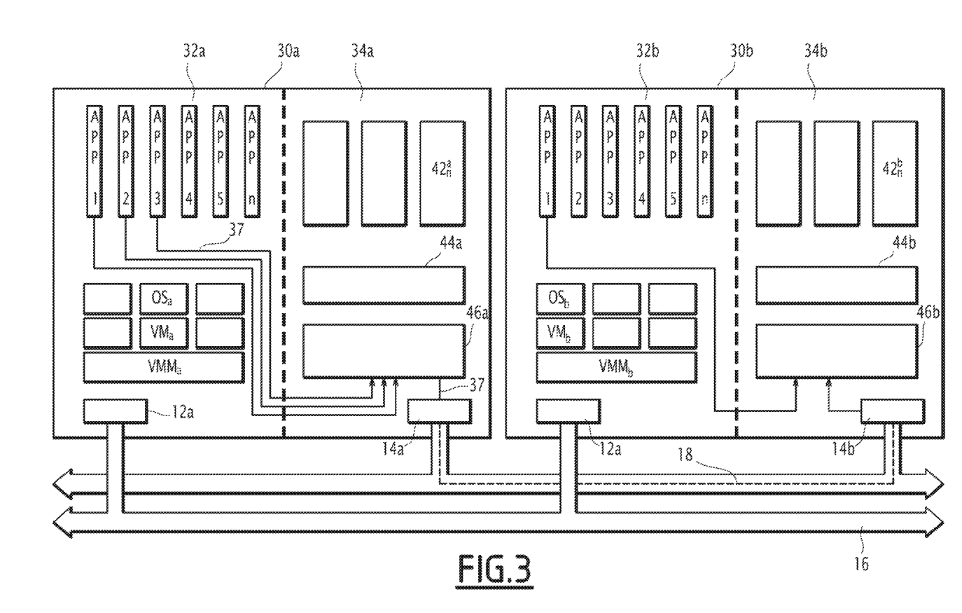

FIG. 3 schematically illustrates an embodiment with interconnected programmable devices;

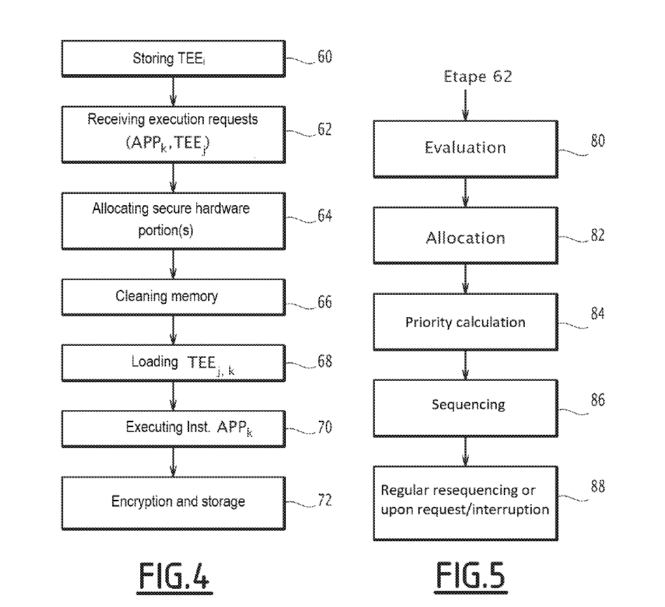

FIG. 4 is a flowchart of the main steps of a method for secure execution of virtual machines according to one embodiment of the invention;

FIG. 5 is a flowchart of the implementation of the step for distributed allocation of secure hardware portions according to one embodiment of the invention.

The invention will be described as it applies in a centralized data processing system including sets of interconnected programmable devices, usable by a plurality of client virtual machines.

Nevertheless, the invention is not limited to this application scenario, and is applicable in any system for execution of applications from a plurality of virtual machines.

FIG. 1 schematically illustrates a centralized processing system 2, in the example comprising two sets 4, 6 of interconnected programmable devices 10. Each programmable device 10 comprises two respective network connection interface modules, denoted 12 and 14, a first interface module 12 allowing the connection to a public communication network 16 and a second interface module 14 allowing the connection to an administration network 18, allowing the implementation of secure communications.

The public communication network 16 is for example the client network of the providers of the centralized processing system (or cloud), allowing the virtual machines of their clients to connect to one another and with the Internet communication network.

In a centralized data processing application, each of the programmable devices 10 operates in virtualized mode, executing several different client virtual machines. This is called multi-tenancy.

In order to allow a secure execution of applications by these virtual machines, preferably, each programmable device is equipped with one or several processors, having one or several computing cores, and making it possible to perform a physically secure execution.

FIG. 2 illustrates a preferred embodiment in which each processor 30 of a programmable device includes two separate hardware portions 32 and 34 respectively corresponding to the standard security level hardware portion and the secure hardware portion.

The hardware portion 32 has a standard security level, used for traditional operation. The hardware portion 34 is a secure hardware portion, with a higher security level than the standard security level. These two portions are partitioned with respect to one another, and access to the secure hardware portion 34 is done through dedicated requests 33, 35.

Each of the hardware portions in connection with its respective execution mode implements several execution privilege levels: a user privilege level (lower) EL₀, and one or several intermediate privilege levels (EL₁ and EL₂ in our example), for the execution of an operating system of the hypervisor, and lastly a higher privilege level (EL₃ in our example) for the firmware in the secure mode.

For example, in the case where the processor used has an ARM v8® architecture, one has a user privilege level EL0 in both modes, a higher privilege level EL1 in both modes, for the execution of an operating system, a higher privilege level EL2, only in the standard mode for the hypervisor, and a maximum privilege level EL3, only in the secure mode.

Thus, user applications 36₁ to 36ₙ are executed at privilege level EL₀, in the standard mode, the execution being supported by an operating system and an execution environment.

In the example of FIG. 2, several user applications APP₁ to APPₙ are considered, as well as several operating systems OS₁ to OS₃, at privilege level EL₁ of the standard mode, each operating system being associated with a virtual machine VM₁ to VM₃.

The execution of the applications APP₁ to APPₙ of the various virtual machines VM₁ to VM₃ is managed by a hypervisor or VMM (Virtual Machine Monitor), denoted 38 in FIG. 2, at privilege level EL₂ of the standard mode.

The secure hardware portion 34 is able to carry out a secure execution environment 40, also called TEE (Trusted Execution Environment), and to execute applications 42₁ to 42ₘ in a partitioned manner, therefore protected relative to any piracy attempts.

Reference is made to secure execution, and the applications 42₁ to 42ₘ executed in a secure manner are also called “trustlets”. A secure execution environment 40 also comprises a secure operating system 44, with privilege level EL₁.

In other words, a TEE comprises an operating system and an execution context for one or several applications to be executed.

The secure hardware portion 34 comprises a secure control module 46, with privilege level EL₃ higher than the privilege level assigned to the module 44, implementing firmware instructions for the secure hardware portion.

According to one embodiment, the firmware implemented by the secure control module 46 is modified by adding code instructions to allow, upon secure execution request for at least one instruction of an application APP₁ to APPₙ of a requesting virtual machine, in particular by changing the visible memory context of the secure execution environment, a distributed use of the secure hardware portions of the processors of the interconnected programmable devices.

FIG. 2 illustrates a single programmable device, but FIG. 3 illustrates two interconnected programmable devices.

The secure control module 46 comprises a module 50 for receiving and processing secure execution requests 33, 35.

For example, in the example of FIG. 2, a first request 33 is sent, for a secure execution of the application APP₁ in its secure execution environment TEE₁, as well as a second request 35 for a secure execution of the application APP₂ in its secure execution environment TEE₂.

The secure control module 46 also comprises a module 52 able to perform a backup, in a shared memory resource zone 60, of a secure execution environment TEEᵢ associated with a virtual machine VMᵢ.

Preferably, the secure execution environment data is encrypted before backup.

A module 54 for allocating a secure hardware portion implements the allocation, upon the secure execution of an application APPₖ in an environment TEEᵢ, of at least one available secure hardware portion belonging to one of the processors of the set of interconnected programmable devices.

A so-called sanitization module 56 performs the cleaning, in particular the reset, of the memory hardware resources used by the secure hardware portion for the execution of code instructions, so as to avoid any possibility of piracy due to successive executions of code instructions coming from different virtual machines. Furthermore, other hardware resources, or peripherals, used for the execution of the application instructions APPₖ, are also cleaned to avoid any risk of piracy.

A loading and execution module 58 loads the secure execution environment TEEᵢ corresponding to the received execution request in the RAM random-access memory, and the secure execution of the application APPₖ.

Preferably, the hardware resources of the selected secure hardware portion 34 are used exclusively for the execution of a given application at a given moment.

FIG. 3 schematically illustrates an implementation of the invention in the context of the interconnection of two processors 30a, 30b of two interconnected programmable devices. To simplify the illustration, the shared memory resources have not been illustrated again in FIG. 3.

Each of the processors 30a, 30b comprises elements similar to the elements previously described for the processor 30 of FIG. 2.

As illustrated in FIG. 3, the secure control module 46a is able to send a secure execution request 37, via the network interface module 14a, to a control module 46b of another processor, which is able to receive it via the network interface module 14b.

In the example, the request 37 is a secure execution instruction of the application APP₃ in an associated secure execution environment TEE₃.

The secure execution environment TEE₃ is decrypted, loaded and executed by the secure hardware portion 34b.

The secure control modules 46a, 46b implement addressing and routing mechanisms for the secure execution requests, each secure execution request being sent by a virtual machine executed by a hardware portion 32a, 32b with a standard security level.

Thus, the respective secure control modules 46a, 46b as they are provided by the processor manufacturers are modified to allow processing of the requests 37 comprising execution instructions by a remote secure hardware portion. Consequently, distributed operation is obtained.

FIG. 4 is a flowchart of the main steps of a method for secure execution of virtual machines by a set of interconnected programmable devices according to one embodiment of the invention.

In this embodiment, the method comprises a first step 60 for storing at least one secure execution environment, denoted TEEᵢ, for each virtual machine VMᵢ that is executed on one of the standard hardware portions of the set of programmable devices of the system.

As mentioned above, each TEEᵢ comprises a secure operating system and an execution context for at least one application.

The TEEᵢ are stored, preferably in encrypted form, in memory resources shared by all of the interconnected processors of the system.

Preferably, only the secure control modules have access to these shared memory resources forming a backup area.

An association between each secure execution environment and the virtual machine and the application to be executed is also stored.

During the reception 62 of at least one request for secure execution of at least one instruction Inst of an application APPₖ by a requesting virtual machine Vmⱼ, a step 64 for allocating at least one available secure hardware portion belonging to one of the processors of the set of interconnected programmable devices is implemented.

Several embodiments of this allocation step are considered and outlined below.

After the allocation step 64, a step 66 for cleaning the memory resources and other peripherals used by the allocated secure hardware portion is implemented, in order to enhance the execution safety of the application to be executed and the applications previously executed. Such other peripherals for example include network resources and encryption accelerators.

In particular, an erasure of the memory resources is implemented during step 66 when the secure hardware portion is already allocated to a TEE_{f}. This step is preceded by an encrypted backup of the context TEE_{f}, as explained below.

The cleaning step is followed by a step 68 for loading, in memory, the secure execution environment TEE_{j,k} previously stored, for the virtual machine VMⱼ and the execution context of the application APPₖ. When the secure execution environments are backed up in encrypted form, a decryption is applied before loading.

The loading step 68 is followed by a step 70 for secure execution of the instruction Inst of the application APPₖ in the TEE_{j,k}.

It should be noted that in one alternative, several secure hardware portions are allocated for the execution of the application APPₖ, as would optionally be the case if the application was executed in secure mode on a processor with several cores.

Additionally, it is typical to allocate a set of memory resources, for example buffers, for the executions implemented in secure hardware mode that will be used to communicate with the client virtual machine of this TEE. This is how the secure applications yield results to the standard applications.

The shared buffers are accessible both via the normal mode and the secure mode, but with different read and write access rights. When the data, for example the TEE_{f}, are backed up in encrypted form, they can be stored in memory zones accessible via the normal mode, with a standard security level.

When one of these shared buffers is modified by the execution of the application APPₖ, consequently modifying the context associated with the secure execution environment TEE_{j,k}, the context of the ‘client’ virtual machine VMⱼ will be modified accordingly to allow the sharing that would have occurred if the TEE had remained in the same processor, in synchronous or asynchronous mode (option to be chosen by the firmware).

Once the execution is complete, a step 72 for encryption and storing of the encrypted secure execution environment is carried out.

FIG. 5 is a flowchart of one embodiment of step 64 for allocating one or several secure hardware portions for the secure and distributed execution of virtual machine applications.

In this embodiment, after receiving a request for secure execution of at least one instruction or sequence of instructions Inst of an application APPₖ by a requesting virtual machine VMⱼ, a step 80 is carried out for evaluating necessary hardware resources for the secure execution environment TEE, associated with said requesting virtual machine VMⱼ. In particular, the computing complexity and/or the quantity of memory and/or the number of execution cores necessary for said secure execution is evaluated.

Step 80 is followed by a step 82 for allocating a number of secure hardware portions and associated memory resources for the execution of an instruction or sequence of instructions Inst of an application APPₖ by a requesting virtual machine VMⱼ.

Step 82 is followed by a step 84 for calculating the execution sequencing priority by the interconnected firmware of the execution requests to be carried out.

Alternatively, step 84 for calculating a priority is carried out before step 82 for allocating secure hardware portions, such that the calculated priorities also apply to the allocation step.

In the case of multiple execution requests from multiple requesting virtual machines, received substantially in parallel, step 84 is followed by a step 86 for the distributed implementation of a sequencing algorithm for the use of secure hardware portions by the secure execution environments TEEi associated with the requesting virtual machines.

The number of TEEᵢ and their execution core needs in some cases exceeds the available secure hardware execution resources.

Various distributed sequencing mechanisms are known, and easily applicable by one skilled in the art for the sequencing and distribution of the TEEᵢ on secure hardware portions.

For example, tourniquet or round-robin mechanisms, or a BVT (borrowed virtual time) mechanism, can be applied.

At regular intervals or upon request, or when events or interruptions occur, a resequencing 88 is carried out, making it possible to reallocate TEEᵢ to other secure hardware portions.

Preferably, the collaboration between the firmware of the secure hardware portions of the programmable devices, whether for the sequencing or the management of events of a secure execution environment, is organized by a simplified DHT (Distributed Hash Table) mechanism for the distributed sharing of the allocation information of the secure hardware portions, events or CPU time allocated to each of the TEEᵢ, or such as Chord or Kademlia.

A collaborative sequencing mode can be chosen from among those cited in the publication “Scheduling in Distributed Systems”, by Dongning Liang et al., accessible on the following website:
http://cseweb.ucsd.edu/classes/sp99/cse221/projects/Scheduling.pdf

In another, less advantageous alternative in terms of security and performance, the invention may include only one network shared between each processor. In this case, the firmware communicates in an encrypted manner, for example by VPN, by using an unsecured network.

1. A method for secure execution of virtual machines by a set of interconnected programmable devices, each programmable device including at least one computing processor having one or several cores, each programmable device being able to execute, simultaneously and/or successively, applications of a plurality of virtual machines, each processor including a hardware portion for standard security level execution and a secure hardware portion for a security level higher than the standard security level, said hardware portions being partitioned.
the method comprising:
storing at least one secure execution environment associated with each virtual machine, each secure execution environment including at least one instruction of an associated application,
following a request for secure execution of at least one series of instructions of an application by a requesting virtual machine,
allocating said secure execution at least one available secure hardware portion belonging to one of the processors of the set of interconnected programmable devices,
loading the secure execution environment associated with said requesting virtual machine in said at least one allocated secure hardware portion,
using the allocated secure hardware portion for the secure execution of said sequence of instructions of the application of the requesting virtual machine.

2. The method according to claim 1, wherein the secure hardware portion comprises memory resources and the method comprises, before loading the secure execution environment, cleaning said memory resources.

3. The method according to claim 2, wherein the secure hardware portion comprises at least one peripheral, the method comprising, before loading the secure execution environment, cleaning each peripheral.

4. The method according to claim 1, further comprising an encryption of the secure execution environment after the secure execution of said sequence of instructions of the application of the requesting virtual machine, and storing of the encrypted secure execution environment.

5. The method according to claim 1, wherein, after the secure execution request for at least one sequence of instructions of an application, the method comprises at least one step for evaluating necessary hardware resources for the secure execution environment associated with said requesting virtual machine, and computing a number of secure hardware portions to be allocated for the execution of the secure application in the associated secure execution environment.

6. The method according to claim 1, wherein, following a request for secure execution of at least one sequence of instructions of an application, the method comprises a step for computing a secure execution sequencing priority of the execution requests.

7. The method according to claim 5, wherein the evaluation of hardware resources comprises an evaluation of computing complexity and/or quantity of memory and/or number of execution cores.

8. The method according to claim 1, comprising, for a plurality of execution requests from a plurality of requesting virtual machines, a distributed implementation of a sequencing algorithm for the use of groups of secure hardware portions by the secure execution environments associated with the requesting virtual machines.

9. The method according to claim 1, wherein the use of a secure hardware portion allocated for the secure execution of at least one instruction of the application of a first requesting virtual machine is exclusive, at a given moment, of any use of said secure hardware portion for the secure execution of at least one instruction of the application of a second requesting virtual machine.

10. A system for secure execution of virtual machines by a set of interconnected programmable devices, each programmable device including at least one computing processor having one or several cores, each programmable device being able to execute, simultaneously and/or successively, applications of a plurality of virtual machines,
each processor including a hardware portion for standard security level execution and a secure hardware portion for a security level higher than the standard security level, said hardware portions being partitioned,
each processor being suitable for:
storing a secure execution environment associated with each virtual machine, each secure execution environment including at least one instruction of an associated application,
following a request for secure execution of at least one series of instructions of an application by a requesting virtual machine,
allocating said secure execution at least one available secure hardware portion belonging to one of the processors of the set of interconnected programmable devices,
loading the secure execution environment associated with said requesting virtual machine in said at least one allocated secure hardware portion,
using the allocated secure hardware portion for the secure execution of said sequence of instructions of the application of the requesting virtual machine.

11. The system for secure execution of virtual machines according to claim 10, including shared memory resources, the system including an encryption module able to encrypt the secure execution environment after the secure execution of said at least one instruction of the application of the requesting virtual machine, and to save the encrypted secure execution environment in the shared memory resources.

12. A computer program product including firmware instructions which, when implemented by one or several computing processors of programmable devices, each computing processor having one or several cores, each programmable device being able to execute, simultaneously and/or successively, applications of a plurality of virtual machines, each processor including a hardware portion for standard security level execution and a secure hardware portion for a security level higher than the standard security level, said hardware portions being partitioned, carry out a method according to claim 1.
